(19) United States
(12) Patent Application Publication
(10) Pub. No.: US 2012/0009044 A1
(43) Pub. Date: Jan. 12, 2012

(54) AUXILIARY MEMBER FOR COIL NAILS

(75) Inventor: Yi-Kuan Lee, Taichung County (TW)

(73) Assignee: SAMSON POWER TOOL CO., LTD., Taichung County (TW)

(21) Appl. No.: 12/832,242

(22) Filed: Jul. 8, 2010

(51) Int. Cl. F16B 15/00

(52) U.S. Cl. 411/441

(57) ABSTRACT

An auxiliary member for coil nails includes a shank and a connection portion which is located at a lateral side of the shank, wherein the shank is pushed by a main pusher of a push mechanism. An extension portion is connected between the shank and the connection portion. The shank and the extension portion are non-parallel to each other, an axis of the shank is not parallel to an axis of the extension portion. The connection portion holds a shank of a last nail of the coil nails.

### FIELD OF THE INVENTION

The present invention relates to coil nails, and more particularly, to an auxiliary member for assisting the last nail to successfully enter the passage of the nail gun.

### BACKGROUND OF THE INVENTION

The conventional coil nails is shown in FIGS. 1 to 3, and generally includes multiple nails 4 which are connected to each other in a pre-set inclination way by copper wires 45, and each nail 4 includes a head 40 and a shank 41. The nails 4 and the wires 45 are then scrolled to be the coil nails.

The coil nails is installed in the magazine (not shown) of a nail gun and the head 40 of the first nail 4 is installed into the slide groove 101 of the connection part 10 of the nail gun and the first nail 4 is pushed left as shown in the drawings until the first nail 4 enters into the passage 11 of the nose 1 of the nail gun. The shank 41 of the second nail 4 is arranged on the main pusher 20 of the push mechanism 2 and the rest of the nails 4 are located in the connection part 10 and the magazine. The cover 15 is then covered on the connection part 10 of the nose 1 and the sub-pusher 16 on the cover 15 is located on the right side of the shank 41 of the second nail 4. The nails 4 are located between the cover 15 and the connection part 10 and are ready to shoot.

When pulling the trigger, the strike pin (not shown) moves fast to shoot the nail 4 in the passage 11 in the nose 1 and the strike pin returns to initial position and ready for the next shoot. The push mechanism 2 is controlled to move toward right, however, the shank 41 of the second nail 4 is stopped by the sub-pusher 16 of the cover 15, so that the main pusher 20 is forced to move over the shank 41 of the second nail 4 and is located beside the shank 41′ of the third nail 4′. Finally, the main pusher 20 of the push mechanism 2 pushes the third nail 4′ toward left to force the shank 41′ of the third nail 4′ pushes the sub-pusher 16 inward and the sub-pusher 16 returns to its original position after the shank 41′ of the third nail 4′ passes. The actions are repeated until only the last nail 4 is in the nail gun. When the last nail 4 enters into the passage 11 which is perpendicular to the ground, the last nail 4 does not have any holding force to hold it so that the last nail 4 easily drops from the passage 11. This means that the last nail 4 is useless and wasted.

The present invention intends to provide an auxiliary member for coil nails wherein the last nail can be successfully sent to the right position to be shot.

### SUMMARY OF THE INVENTION

The present invention relates to an auxiliary member which includes a shank and a connection portion which is connected to the lateral side of the shank by a extension portion which is not parallel to the shank. The connection portion holds the last nail of the coil nails to ensure that the last nail is correctly sent to eh passage of the nail gun.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the conventional coil nails are installed to a nail gun;

FIG. 2 shows that the conventional coil nails are in operation status in a nail gun;

FIG. 3 shows that the last nail is to be used of the conventional coil nails in a nail gun;

FIG. 4 is an exploded view to show the nails and the auxiliary members of the present invention;

FIG. 5 is a perspective view to show that the last nail is held by the auxiliary members of the present invention;

FIG. 6 is a perspective view to show another embodiment of the auxiliary members of the present invention;

FIG. 7 is a plane view to show the coil nails with the auxiliary members of the present invention connected to the last nail;

FIG. 8 shows that the coil nails with the auxiliary members of the present invention are installed to a nail gun;

FIG. 9 shows that the push mechanism in FIG. 8 moves backward;

FIG. 10 shows that the last nail in FIG. 9 is sent to the passage of the nail gun, and

FIG. 11 shows yet another embodiment of the auxiliary members of the present invention.

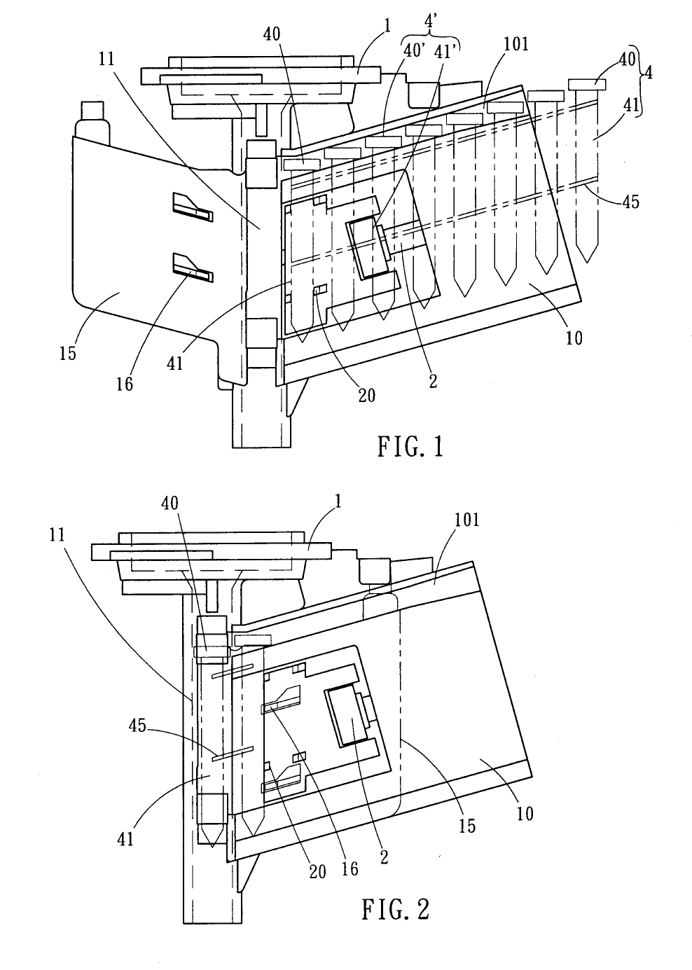

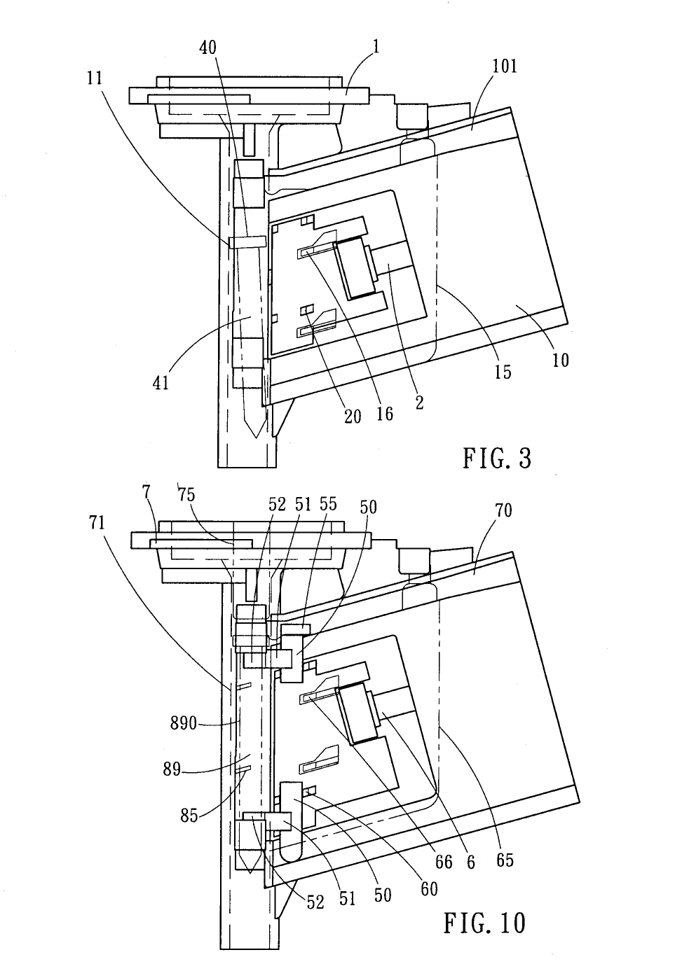

### DETAILED DESCRIPTION OF THE PREFERRED EMBODIMENT

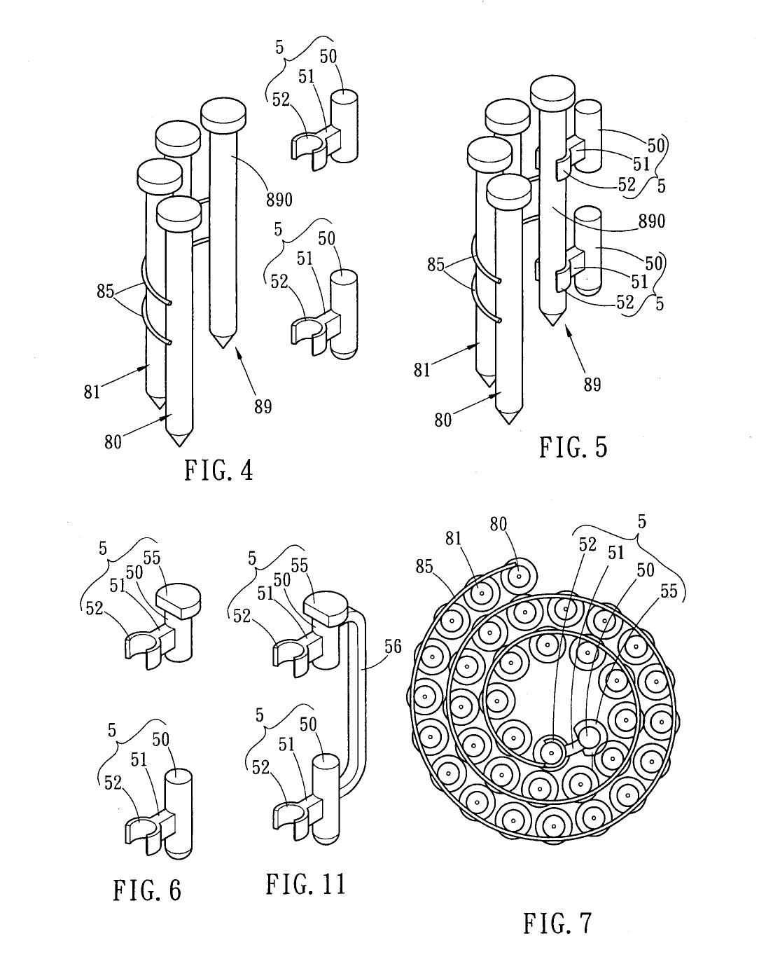

Referring to FIGS. 4 to 10, the auxiliary member 5 of the present invention comprises a shank 50 and a connection portion 52 which is connected at a lateral side of the shank 50 directly or by an extension portion 51. The shank 50 is pushed by a main pusher 60 of a push mechanism 6. The extension portion 51 is connected between the shank 50 and the connection portion 52, and the shank 50 and the extension portion 51 are non-parallel to each other. In other words, the axis of the shank 50 is not parallel to the axis of the extension portion 51. The connection portion 52 holds the last nail 89 of the coil nails as shown in FIGS. 5 and 7. The distance between the shank 50 and the connection portion 52 is multiple times of a distance between two adjacent nails 80, 81 such that the main pusher 60 of the push mechanism 6 can catch the nails 80, 81. Besides, the connection portion 52 can be an opened curved surface, a flat surface or a hollow cylinder, so that the connection portion 52 is able to hold, mount to or adhered to the shank 890 of the last nail 89.

FIG. 6 shows that the shank 50 is connected with a head 55 which is adapted to be guided into the slot 70 of the nose 7 of nail guns.

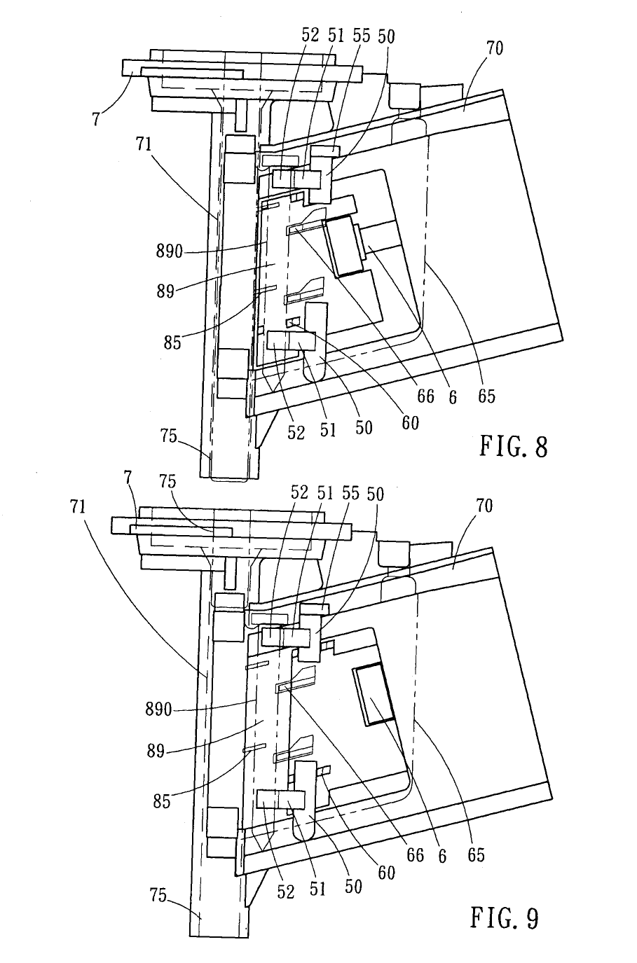

When in use, the strike pin 75 moves fast to shoot the nail 80 in the passage 71 in the nose 7 and the strike pin 75 then returns to initial position and ready for the next shoot as shown in FIG. 8. The push mechanism 6 is controlled to move toward right, however, the shank 890 of the last nail 89 is stopped by the sub-pusher 66 of the cover 65, so that the main pusher 60 is forced to move outward and removed from the shank 890 of the last nail 89, and then is located beside the shank 50 of the auxiliary member 5. Finally, the main pusher 60 of the push mechanism 6 pushes the auxiliary member 5 toward left to force the shank 50 of the auxiliary member 5 pushes the sub-pusher 66 inward and the sub-pusher 66 returns to its original position after the shank 50 of the auxiliary member 5 passes. By this procedure, the last nail 89 is sent to the correct position in the passage 71 as shown in FIG. 10. The procedure also avoids the last nail 89 from dropping from the passage 71.

FIG. 11 shows another embodiment and the difference is that the shank 50 of the auxiliary member 5 is changed from a single rod to two rods which are connected by a link 56. The shank 50 may include a head 55.

An extension portion 55 is connected at a lateral side of the shank 50 and the shank 50 and the extension portion 51 are non-parallel to each other. A connection portion 52 is connected to a distal end of the extension portion 51 and the connection portion 52 holds the last nail 89 of the coil nails which are connected by the connection members 85. The distance between the shank 50 and the connection portion 52 is multiple times of a distance between two adjacent nails 80, 81 such that the main pusher 60 of the push mechanism 6 can catch the nails 80, 81. Besides, the connection portion 52 can be an opened curved surface, a flat surface or a hollow cylinder, so that the connection portion 52 is able to hold, mount to or adhered to the shank 890 of the last nail 89.

While we have shown and described the embodiment in accordance with the present invention, it should be clear to those skilled in the art that further embodiments may be made without departing from the scope of the present invention.

What is claimed is:

1. An auxiliary member for coil nails, comprising:
a shank and a connection portion which is located at a lateral side of the shank, the shank being adapted to be pushed by a main pusher of a push mechanism, the connection portion adapted to be connected to a last nail of the coil nails connected by connection members.

2. The auxiliary member for coil nails as claimed in claim 1, wherein the connection portion is directly connected to the shank.

3. The auxiliary member for coil nails as claimed in claim 1, wherein an extension portion is connected between the shank and the connection portion.

4. The auxiliary member for coil nails as claimed in claim 3, wherein the shank and the extension portion are non-parallel to each other.

5. The auxiliary member for coil nails as claimed in claim 4, wherein an axis of the shank is not parallel to an axis of the extension portion.

6. The auxiliary member for coil nails as claimed in claim 2, wherein a distance between the shank and the connection portion is multiple times of a distance between two adjacent nails.

7. The auxiliary member for coil nails as claimed in claim 6, wherein the shank is composed of two rods and a link is connected between the two rods.

8. The auxiliary member for coil nails as claimed in claim 4, wherein the shank is connected with a head which is adapted to be guided into a slot of a nose of nail guns.

9. The auxiliary member for coil nails as claimed in claim 8, wherein the shank is connected to the connection portion by the extension portion and the connection portion is an opened curved surface, a flat surface or a hollow cylinder, the connection portion is adapted to hold a shank of a last nail.

10. The auxiliary member for coil nails as claimed in claim 8, wherein the shank is connected to the connection portion by the extension portion and the connection portion is an opened curved surface, a flat surface or a hollow cylinder, the connection portion is adapted to hold a connection member of nails.

11. The auxiliary member for coil nails as claimed in claim 7, wherein the shank is connected with a head which is adapted to be guided into a slot of a nose of nail guns.

12. The auxiliary member for coil nails as claimed in claim 11, wherein the shank is connected to the connection portion by the extension portion and the connection portion is an opened curved surface, a flat surface or a hollow cylinder, the connection portion is adapted to hold a shank of a last nail.

13. The auxiliary member for coil nails as claimed in claim 11, wherein the shank is connected to the connection portion by the extension portion and the connection portion is an opened curved surface, a flat surface or a hollow cylinder, the connection portion is adapted to hold a connection member of nails.
